(19) United States
(12) Patent Application Publication
(10) Pub. No.: US 2015/0349929 A1
(43) Pub. Date: Dec. 3, 2015

(54) EVOLVED NODE-B, USER EQUIPMENT, AND METHODS FOR HYBRID AUTOMATIC REPEAT REQUEST (HARQ) COMMUNICATION

(71) Applicants: Abhijeet Bhorkar, Fremont, CA (US); Pingping Zong, Randolph, NJ (US); Utsaw Kumar, Foster City, CA (US); Christian Ibars Casas, Santa Clara, CA (US); Hyejung Jung, Palatine, IL (US)

(72) Inventors: Abhijeet Bhorkar, Fremont, CA (US); Pingping Zong, Randolph, NJ (US); Utsaw Kumar, Foster City, CA (US); Christian Ibars Casas, Santa Clara, CA (US); Hyejung Jung, Palatine, IL (US)

(21) Appl. No.: 14/669,176

(22) Filed: Mar. 26, 2015

Related U.S. Application Data
(60) Provisional application No. 62/006,754, filed on Jun. 2, 2014.
(60) Provisional application No. 62/036,523, filed on Aug. 12, 2014.

(51) Int. Cl. H04L 1/18; H04L 27/26; H04W 72/04; H04L 1/20

(52) U.S. Cl. CPC H04L 1/1812; H04L 1/201; H04L 27/2627; H04W 72/042; H04W 72/0413

(57) ABSTRACT

Embodiments of an Evolved Node-B (eNB) and methods for HARQ transmission are disclosed herein. The eNB may transmit, to a reduced-latency User Equipment (UE), an initial HARQ block and a diversity HARQ block for a reduced-latency data block. A sub-frame spacing between the transmissions of the HARQ blocks may be less than a sub-frame spacing used for transmissions of HARQ blocks to UEs not operating as reduced-latency UEs. The HARQ blocks for the reduced-latency data block may be transmitted in a reduced-latency region of time and frequency resources reserved for HARQ processes with reduced-latency UEs. In addition, HARQ blocks may be transmitted in time and frequency resources exclusive of the reduced-latency region to other UEs not operating as reduced-latency UEs.

### PRIORITY CLAIM

This application claims priority under 35 USC 119(e) to U.S. Provisional Patent Application Ser. No. 62/036,523 filed Aug. 12, 2014 [reference number P70715Z (4884.214PRV)], and to U.S. Provisional Patent Application Ser. No. 62/006,754 filed Jun. 2, 2014 [reference number P68626Z], both of which are incorporated herein by reference in its entirety.

### TECHNICAL FIELD

Embodiments pertain to wireless communications. Some embodiments relate to cellular communication networks including 3GPP (Third Generation Partnership Project) networks, 3GPP LTE (Long Term Evolution) networks, and 3GPP LTE-A (LTE Advanced) networks, although the scope of the embodiments is not limited in this respect. Some embodiments relate to hybrid automatic repeat request (HARQ) communication. Some embodiments relate to low-latency or reduced-latency communication.

### BACKGROUND

User Equipment (UE) operating in a cellular network may support various applications that operate according to different characteristics, such as latency of packet exchange with the network. Some applications, such as mission critical applications and real-time gaming, may benefit from a relatively low latency. Other applications, such as file transfer, may be able to operate under relaxed latency specifications, in comparison. As the network may need to support these and other applications simultaneously in some cases, there is a general need for methods and systems for supporting applications with different latency characteristics. In addition, methods and systems for reducing latency are also needed, including those that may reduce latency associated with the air interface.

### BRIEF DESCRIPTION OF THE DRAWINGS

FIG. 1 is a functional diagram of a 3GPP network in accordance with some embodiments;

FIG. 2 is a functional diagram of a User Equipment (UE) in accordance with some embodiments;

FIG. 3 is a functional diagram of an Evolved Node-B (eNB) in accordance with some embodiments;

FIG. 4 illustrates an example scenario for multiple Hybrid Automatic Repeat Request (HARQ) communication processes in accordance with some embodiments;

FIG. 5 illustrates the operation of a method of HARQ communication in accordance with some embodiments;

FIG. 6 illustrates an example of a sub-frame in accordance with some embodiments;

FIG. 7 illustrates another example of a sub-frame in accordance with some embodiments;

FIG. 8 illustrates another example of a sub-frame in accordance with some embodiments;

FIG. 9 illustrates the operation of another method of HARQ communication in accordance with some embodiments;

FIG. 10 illustrates an example of downlink and uplink scheduling in accordance with some embodiments;

FIG. 11 illustrates another example of downlink and uplink scheduling in accordance with some embodiments;

FIG. 12 illustrates another example of downlink and uplink scheduling in accordance with some embodiments;

FIG. 13 illustrates another example of downlink and uplink scheduling in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

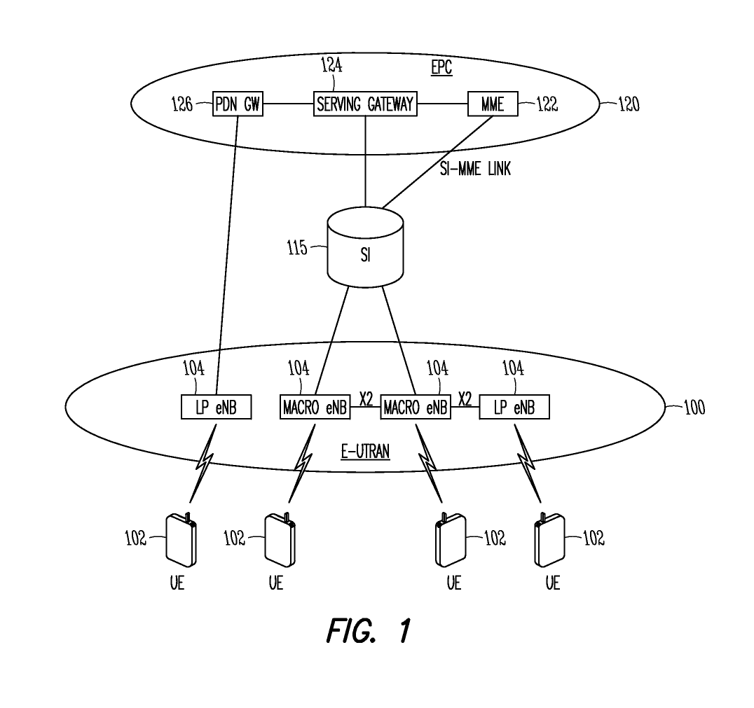

FIG. 1 is a functional diagram of a 3GPP network in accordance with some embodiments. The network comprises a radio access network (RAN) (e.g., as depicted, the E-UTRAN or evolved universal terrestrial radio access network) 100 and the core network 120 (e.g., shown as an evolved packet core (EPC)) coupled together through an S1 interface 115. For convenience and brevity sake, only a portion of the core network 120, as well as the RAN 100, is shown.

The core network 120 includes a mobility management entity (MME) 122, a serving gateway (serving GW) 124, and packet data network gateway (PDN GW) 126. The RAN 100 includes Evolved Node-B's (eNBs) 104 (which may operate as base stations) for communicating with User Equipment (UE) 102. The eNBs 104 may include macro eNBs and low power (LP) eNBs. In accordance with some embodiments, the eNB 104 may transmit, for reception at the UE 102, Hybrid Automatic Repeat Request (HARQ) packets for a data block. The eNB 104 may also receive a HARQ acknowledgement indicator for the data block, which may indicate whether or not the UE 102 has successfully decoded the data block.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 100, and routes data packets between the RAN 100 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

The eNBs 104 (macro and micro) terminate the air interface protocol and may be the first point of contact for a UE 102. In some embodiments, an eNB 104 may fulfill various logical functions for the RAN 100 including but not limited to RNC (radio network controller functions) such as radio bearer management, uplink and downlink dynamic radio resource management and data packet scheduling, and mobility management. In accordance with embodiments, UEs 102 may be configured to communicate Orthogonal Frequency Division Multiplexing (OFDM) communication signals with an eNB 104 over a multicarrier communication channel in accordance with an Orthogonal Frequency Division Multiple Access (OFDMA) communication technique. The OFDM signals may comprise a plurality of orthogonal subcarriers.

The S1 interface 115 is the interface that separates the RAN 100 and the EPC 120. It is split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

In some embodiments, a downlink resource grid may be used for downlink transmissions from an eNB 104 to a UE 102, while uplink transmission from the UE 102 to the eNB 104 may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element (RE). Each resource grid comprises a number of resource blocks (RBs), which describe the mapping of certain physical channels to resource elements. Each resource block comprises a collection of resource elements and in the frequency domain and may represent the smallest quanta of resources that currently can be allocated. There are several different physical downlink channels that are conveyed using such resource blocks. With particular relevance to this disclosure, two of these physical downlink channels are the physical downlink shared channel and the physical down link control channel.

The physical downlink shared channel (PDSCH) carries user data and higher-layer signaling to a UE 102 (FIG. 1). The physical downlink control channel (PDCCH) carries information about the transport format and resource allocations related to the PDSCH channel, among other things. It also informs the UE 102 about the transport format, resource allocation, and HARQ information related to the uplink shared channel. Typically, downlink scheduling (assigning control and shared channel resource blocks to UEs 102 within a cell) is performed at the eNB 104 based on channel quality information fed back from the UEs 102 to the eNB 104, and then the downlink resource assignment information is sent to a UE 102 on the control channel (PDCCH) used for (assigned to) the UE 102.

The PDCCH uses CCEs (control channel elements) to convey the control information. Before being mapped to resource elements, the PDCCH complex-valued symbols are first organized into quadruplets, which are then permuted using a sub-block inter-leaver for rate matching. Each PDCCH is transmitted using one or more of these control channel elements (CCEs), where each CCE corresponds to nine sets of four physical resource elements known as resource element groups (REGs). Four QPSK symbols are mapped to each REG. The PDCCH can be transmitted using one or more CCEs, depending on the size of DCI and the channel condition. There may be four or more different PDCCH formats defined in LTE with different numbers of CCEs (e.g., aggregation level, L=1, 2, 4, or 8).

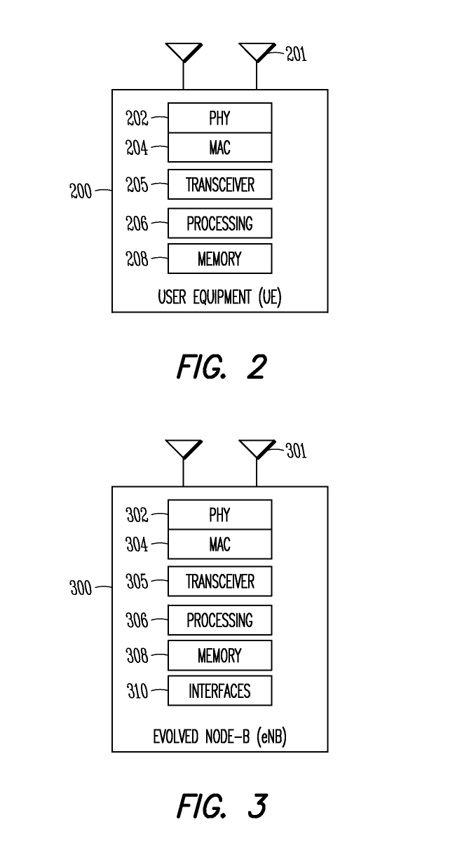

FIG. 2 is a functional diagram of a User Equipment (UE) in accordance with some embodiments. FIG. 3 is a functional diagram of an Evolved Node-B (eNB) in accordance with some embodiments. It should be noted that in some embodiments, the eNB 300 may be a stationary non-mobile device. The UE 200 may be suitable for use as a UE 102 as depicted in FIG. 1, while the eNB 300 may be suitable for use as an eNB 104 as depicted in FIG. 1. The UE 200 may include physical layer circuitry 202 and a transceiver 205, one or both of which may enable transmission and reception of signals to and from the eNB 300, other eNBs, other UEs or other devices using one or more antennas 201. As an example, the physical layer circuitry 202 may perform various encoding and decoding functions that may include formation of baseband signals for transmission and decoding of received signals. As another example, the transceiver 205 may perform various transmission and reception functions such as conversion of signals between a baseband range and a Radio Frequency (RF) range. Accordingly, the physical layer circuitry 202 and the transceiver 205 may be separate components or may be part of a combined component. In addition, some of the functionality described may be performed by a combination that may include one, any or all of the physical layer circuitry 202, the transceiver 205, and other components or layers.

The eNB 300 may include physical layer circuitry 302 and a transceiver 305, one or both of which may enable transmission and reception for transmission and reception of signals to and from the UE 200, other eNBs, other UEs or other devices using one or more antennas 301. The physical layer circuitry 302 and the transceiver 305 may perform various functions similar to those described regarding the UE 200 previously. Accordingly, the physical layer circuitry 302 and the transceiver 305 may be separate components or may be part of a combined component. In addition, some of the functionality described may be performed by a combination that may include one, any or all of the physical layer circuitry 302, the transceiver 305, and other components or layers.

The UE 200 may also include medium access control layer (MAC) circuitry 204 for controlling access to the wireless medium, while the eNB 300 may also include medium access control layer (MAC) circuitry 304 for controlling access to the wireless medium. The UE 200 may also include processing circuitry 206 and memory 208 arranged to perform the operations described herein. The eNB 300 may also include processing circuitry 306 and memory 308 arranged to perform the operations described herein. The eNB 300 may also include one or more interfaces 310, which may enable communication with other components, including other eNBs 104 (FIG. 1), components in the EPC 120 (FIG. 1) or other network components. In addition, the interfaces 310 may enable communication with other components that may not be shown in FIG. 1, including components external to the network. The interfaces 310 may be wired or wireless or a combination thereof.

The antennas 201, 301 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 201, 301 may be effectively separated to take advantage of spatial diversity and the different channel characteristics that may result.

In some embodiments, the UE 200 or the eNB 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the UE 200 or eNB 300 may be configured to operate in accordance with 3GPP standards, although the scope of the embodiments is not limited in this respect. Mobile devices or other devices in some embodiments may be configured to operate according to other protocols or standards, including IEEE 802.11 or other IEEE standards. In some embodiments, the UE 200, eNB 300 or other device may include one or more of a keyboard, a display, a non-volatile memory port, multiple antennas, a graphics processor, an application processor, speakers, and other mobile device elements. The display may be an LCD screen including a touch screen.

Although the UE 200 and the eNB 300 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

In accordance with embodiments, the eNB 104 may transmit, to a reduced-latency UE 102, an initial HARQ block and a diversity HARQ block for a reduced-latency data block. A sub-frame spacing between the transmissions of the HARQ blocks may be less than a sub-frame spacing used for transmissions of HARQ blocks to UEs 102 not operating as reduced-latency UEs 102. The HARQ blocks for the reduced-latency data block may be transmitted in a reduced-latency region of time and frequency resources reserved for HARQ processes with reduced-latency UEs 102. In addition, HARQ blocks may be transmitted in time and frequency resources exclusive of the reduced-latency region to other UEs 102 not operating as reduced-latency UEs 102. These embodiments are described in more detail below.

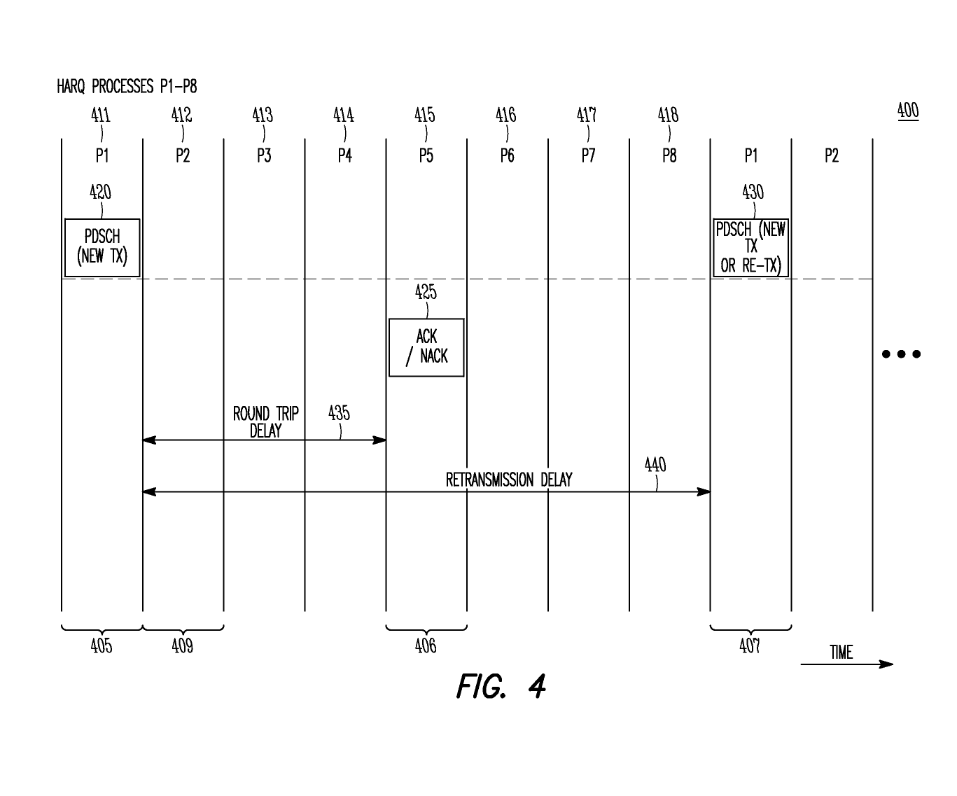

FIG. 4 illustrates an example scenario for multiple Hybrid Automatic Repeat Request (HARQ) communication processes in accordance with some embodiments. In the scenario 400, Multiple HARQ processes P1-P8 (labeled 411-418 in FIG. 4) are supported by the eNB 104 in a staggered configuration. As part of HARQ process P1, a PDSCH block 420 (or a HARQ block based on a first data block) may be transmitted during sub-frame 405 for reception at the UE 102. The UE 102 may attempt to decode the PDSCH block 420 to produce the first data block, and may communicate the result of the decoding back to the eNB 104 as part of the ACK/NACK 425 during sub-frame 406. If the decoding is successful, the next PDSCH block 430 transmitted during sub-frame 407 may include a HARQ block based on a second, new data block. However, if the decoding is not successful, the PDSCH block 430 may include a retransmission of the previous HARQ block (or another diversity version of it). Accordingly, the UE 102 may attempt to decode the first data block again, and may use diversity combining techniques in the decoding process.

As shown in FIG. 4, the round trip delay (RTD) 435 is the time between sub-frame 405 and sub-frame 406, and may represent the time between PDSCH 420 transmission by the eNB 104 and ACK/NACK 425 transmission by the UE 102. The retransmission delay 440 is the time between sub-frame 405 and sub-frame 407, and may represent the time between PDSCH 420 transmission and PDSCH 430 transmission. As shown, the RTD 435 is three sub-frames while the retransmission delay 440 is eight sub-frames. These delays may be selected based on estimated or specified decoding times in some cases.

The process P2 may utilize the same values for the RTD 435 and retransmission delay 440, and may also transmit and receive similar PDSCH and ACK/NACK in sub-frames occurring one sub-frame after those used by the process P1. The remaining processes may then be supported at appropriate delays, and therefore a set of time and frequency resources may support the eight processes P1-P8.

As an example, a Long Term Evolution (LTE) sub-frame in 3GPP standards may span one millisecond. In that case, the RTD may be three milliseconds and the retransmission delay may be eight milliseconds. In some cases, applications may benefit from low latency exchanging of data packets. Accordingly, there may be a need for reduction of various delays and latencies throughout the system, which may include these air-interface delays (RTD and retransmission delays). For instance, an RTD of one millisecond or below may be specified in some cases, which may be referred to as “reduced-latency” or “low-latency.”

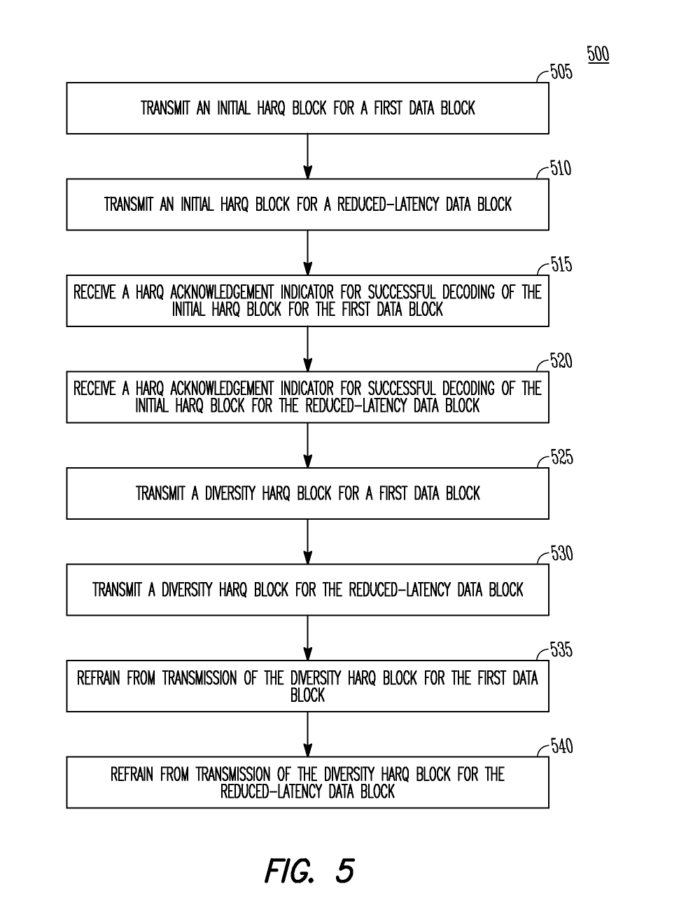

FIG. 5 illustrates the operation of a method of HARQ communication in accordance with some embodiments. It is important to note that embodiments of the method 500 may include additional or even fewer operations or processes in comparison to what is illustrated in FIG. 5. In addition, embodiments of the method 500 are not necessarily limited to the chronological order that is shown in FIG. 5. In describing the method 500, reference may be made to FIGS. 1-4 and 6-13, although it is understood that the method 500 may be practiced with any other suitable systems, interfaces and components.

In addition, while the method 500 and other methods described herein may refer to eNBs 104 or UEs 102 operating in accordance with 3GPP or other standards, embodiments of those methods are not limited to just those eNBs 104 or UEs 102 and may also be practiced by other mobile devices, such as a Wi-Fi access point (AP) or user station (STA). Moreover, the method 500 and other methods described herein may be practiced by wireless devices configured to operate in other suitable types of wireless communication systems, including systems configured to operate according to various IEEE standards such as IEEE 802.11.

At operation 505 of the method 500, an initial HARQ block for a first data block may be transmitted as part of a HARQ process with a first UE 102. At operation 510, an initial HARQ block for a reduced-latency data block may be transmitted as part of a HARQ process with a reduced-latency UE 102. In some embodiments, the reduced-latency UE 102 may be a UE 102 configured to operate in a reduced-latency mode while the first UE 102 may be a UE 102 that is not configured to operate in the reduced-latency mode. Operation in such modes may be configurable in some cases. As a non-limiting example, either or both of the reduced-latency UE 102 and the first UE 102 may be capable of operation in the reduced-latency mode or in a normal mode. In some embodiments, a legacy UE 102 may operate in the normal mode, but these embodiments are not limiting.

The initial HARQ block for the first data block may be based at least partly on the first data block. Accordingly, the first data block may include data bits that may be processed by various encoding functions as part of producing the initial HARQ block. The encoding functions may include some or all of forward error correction (FEC), puncturing, interleaving, bit-to-symbol mapping, and other suitable functions. As an example, the initial HARQ block may include modulated symbols (constellation points) of any suitable modulation such as binary phase-shift keying (BPSK), quadrature phase-shift keying (QPSK), quadrature amplitude modulation (QAM) or other.

In some embodiments, the initial HARQ block may be transmitted using one or more OFDM signals. Though not limited as such, frequency resources of the OFDM signals may include multiple Resource Elements (REs), and multiple REs contiguous in frequency may be grouped to form multiple Resource Blocks (RBs). As a non-limiting example, 12 REs may form an RB in 3GPP or other standards. Time resources of the OFDM signals may include multiple OFDM symbols or OFDM symbol periods. In some embodiments, modulated symbols included in the initial HARQ block may be mapped to various REs and OFDM symbols as part of forming OFDM signals for transmission.

It should be noted that techniques and other aspects related to a particular HARQ block and/or a particular data block may be described herein for discussion or illustrative purposes, but embodiments are not limited to those particular blocks or block types. Accordingly, the above discussion regarding the initial HARQ block for the first data block (along with its formation, transmission, and other features) is not limited to the initial HARQ block or to the first data block, and may be applied to other HARQ blocks and/or data blocks, including those described herein. As an example, the initial HARQ block for the reduced-latency data block at operation 510 may be used. As will be discussed later, diversity HARQ blocks for the first data block or the reduced-latency data block may also be used. In addition, other types of HARQ blocks and data blocks may be used in some cases. As another example, additional diversity HARQ blocks beyond the diversity HARQ block, such as a second or third diversity HARQ block for a particular data block, may be used.

It should be noted that the eNB 104 may support multiple HARQ sessions simultaneously with different UEs 102, as previously described. In some embodiments, the multiple HARQ sessions may be supported with any suitable number of UEs 102. The UEs 102 may include UEs 102 operating in the reduced-latency mode, UEs 102 operating in the normal mode, UEs 102 operating in other modes, or any suitable combination thereof. As a non-limiting example, the eNB 104 may support eight HARQ sessions with UEs 102 operating in the normal mode, similar to the scenario 400 previously described. The eNB 104 may also support multiple HARQ sessions with UEs 102 operating in the reduced-latency mode in a similar manner. That is, the eNB 104 may support multiple HARQ sessions with reduced-latency UEs 102 in time and frequency resources reserved for reduced-latency operation, and may simultaneously support multiple HARQ sessions with UEs 102 operating in the normal mode in time and frequency resources exclusive to those reserved for reduced-latency operation.

Returning to the method 500, a HARQ acknowledgement indicator for successful decoding of the initial HARQ block for the first data block may be received at operation 515. In some embodiments, the HARQ acknowledgement indicator may indicate successful or unsuccessful decoding of the first data block by the first UE 102, and the decoding result may reflect an attempt by the first UE 102 to decode the first data block using the received initial HARQ block for the first data block. Accordingly, the HARQ acknowledgement indicator may include or may be an ACK/NACK or similar, and may include additional related information in some cases. The reception of the HARQ acknowledgement indicator may be part of the HARQ process with the first UE 102, though embodiments are not so limited.

At operation 520, a HARQ acknowledgement indicator for successful decoding of the initial HARQ block for the reduced-latency data block may be received. The reception of the HARQ acknowledgement indicator may be part of the HARQ process with the reduced-latency UE 102, though embodiments are not so limited. Though not limited as such, the previous discussion related to operation 515 may be applicable to operation 520, and analogous or similar techniques may be used in some cases. For instance, a decoding result included in the HARQ acknowledgement indicator may reflect an attempt by the reduced-latency UE 102 to decode the reduced-latency data block using the received initial HARQ block for the reduced-latency data block.

In some embodiments, the HARQ acknowledgement indicator for successful decoding of the initial HARQ block for the reduced-latency data block may be received within one millisecond of the transmission of the initial HARQ block for the reduced-latency data block. Accordingly, when a time lapse between the transmission of the HARQ block by the eNB 104 and the reception of the indicator at the eNB 104 (or the transmission of the indicator by the UE 102) is less than one millisecond or another specified time value or a desired time value lesser than an existing RTD for eNB 104, the HARQ process may be considered “reduced-latency”or “low latency.” The RTD and retransmission delays, as previously described, may be lower for UEs 102 operating in the reduced-latency mode than for UEs 102 operating in the normal mode.

Embodiments are not limited to the value of one millisecond for the time lapse, as other values for the time lapse may also be specified for the reduced-latency operation. In addition, values for time durations other than the time lapse just described, including the RTD and retransmission delays, may also be specified for the reduced-latency operation. Embodiments are also not limited to the use of “less than” as a logical operator in the classification of the reduced-latency operation. For instance, “less than or equal to” or other logical operators may also be used.

As an example of reduced-latency operation, a specified maximum value for the time lapse between the HARQ transmission and the reception of the indicator may be selected from a range between 0.5 milliseconds and 1.5 milliseconds. As another example, a value lower than 0.5 milliseconds or a value higher than 1.5 milliseconds may be used. As another example, the time lapse for the reduced-latency mode may be specified in comparison to an analogous time lapse related to HARQ processes used for UEs 102 operating in a “normal” mode or not operating in the reduced-latency mode. For instance, a reduced-latency HARQ process may be considered low latency or reduced-latency when the time lapse described above is 25% or less of an analogous time lapse of a HARQ process used for UEs 102 operating in the normal mode. The value of 25% is given as an example, and it is understood that other suitable values may be specified or used.

At operation 525, a diversity HARQ block for the first data block may be transmitted as part of the first HARQ process with the first UE 102. In some embodiments, the diversity HARQ block may be transmitted such that the transmissions of the HARQ blocks (initial and diversity) for the first data block occur during Long Term Evolution (LTE) sub-frames that are spaced apart in time by a predetermined HARQ interval.

At operation 530, a diversity HARQ block for the reduced-latency data block may be transmitted as part of the reduced-latency HARQ process with the reduced-latency UE 102. In some embodiments, the diversity HARQ block may be transmitted such that the transmissions of the HARQ blocks (initial and diversity) for the reduced-latency data block occur during LTE sub-frames that are spaced apart in time by a predetermined reduced-latency HARQ interval that is less than the HARQ interval. That is, the diversity HARQ block may be transmitted according to a predetermined spacing of LTE sub-frames in comparison to a corresponding initial HARQ block, and the spacing for UEs 102 operating in a reduced-latency mode may be lower than the spacing for UEs 102 operating in a normal mode. In some embodiments, a retransmission time, which may be a turnaround time associated with an interval between transmissions of the initial and diversity HARQ blocks, may be less for the reduced-latency HARQ process than for the first HARQ process. As a non-limiting example, the turnaround time for the reduced-latency HARQ process may be 25% of the turnaround time for the normal HARQ process.

In some embodiments, the transmission of the diversity HARQ block (for any HARQ process) may occur when the corresponding HARQ acknowledgement indicator indicates a decoding failure for the data block. The decoding failure may refer to a failure in an attempt by the UE 102 to decode the data block based at least partly on the initial HARQ block. The transmission may also occur when the HARQ acknowledgement indicator is not successfully received at the eNB 104, in some cases. Accordingly, the transmission may occur when the data block is not acknowledged as successfully decoded by the HARQ acknowledgement indicator.

As described earlier, the diversity HARQ block (for any HARQ process) may include some or all of the modulated symbols included in the corresponding initial HARQ block, but is not limited as such. In some embodiments, the diversity HARQ block and the initial HARQ block may both be based on the data block and may use some or all of the same encoding functions. As an example, different sets of parity bits from the same FEC encoder may be used for the formations of the initial HARQ block and the diversity HARQ block. As another example, different interleavers may be used for the different HARQ blocks. As another example, the two HARQ blocks may include the same modulated symbols and the diversity HARQ block may be a copy of the initial HARQ block. These examples may illustrate different possibilities for the HARQ blocks, but are not limiting, as other suitable techniques may be used.

At operation 535, the eNB 104 may refrain from transmission of the diversity HARQ block for the first data block when the received HARQ acknowledgement indicator for the first data block indicates successful decoding of the first data block based on the initial HARQ block for the first data block. The decoding may take place at the first UE 102. Accordingly, when the eNB 104 is notified that the first data block has been successfully received, it may be considered unnecessary to transmit (or even to form or compute) the diversity HARQ block for the first data block. At operation 540, the eNB 104 may refrain from transmission of the diversity HARQ block for the reduced-latency data block when the received HARQ acknowledgement indicator for the reduced-latency data block indicates successful decoding of the reduced-latency data block based on the initial HARQ block for the reduced-latency data block. The decoding may take place at the reduced-latency UE 102. As described previously regarding the first data block, it may be considered unnecessary to transmit (or even to form or compute) the diversity HARQ block for the reduced-latency data block when the eNB 104 is notified that the data block has already been successfully decoded.

In some embodiments, the HARQ blocks for the reduced-latency data block may be transmitted in time and frequency resources reserved for HARQ processes with reduced-latency UEs 102. In addition, the HARQ blocks for the first data block may be transmitted in time and frequency resources exclusive of those reserved for HARQ processes with reduced-latency UEs 102. Accordingly, the time and frequency resources may include resources reserved for or allocated for reduced-latency HARQ processes and resources that may be used for normal HARQ processes, in some cases.

In some embodiments, the time and frequency resources may include one or more LTE sub-frames, which may comprise a reduced-latency region of time and frequency resources reserved for HARQ processes with reduced-latency UEs and a normal region of time and frequency resources exclusive to the reduced-latency region. Accordingly, time and frequency resources of each LTE sub-frame may comprise a reduced-latency portion reserved for reduced-latency HARQ transmissions and a normal portion exclusive to the reduced-latency portion in some cases.

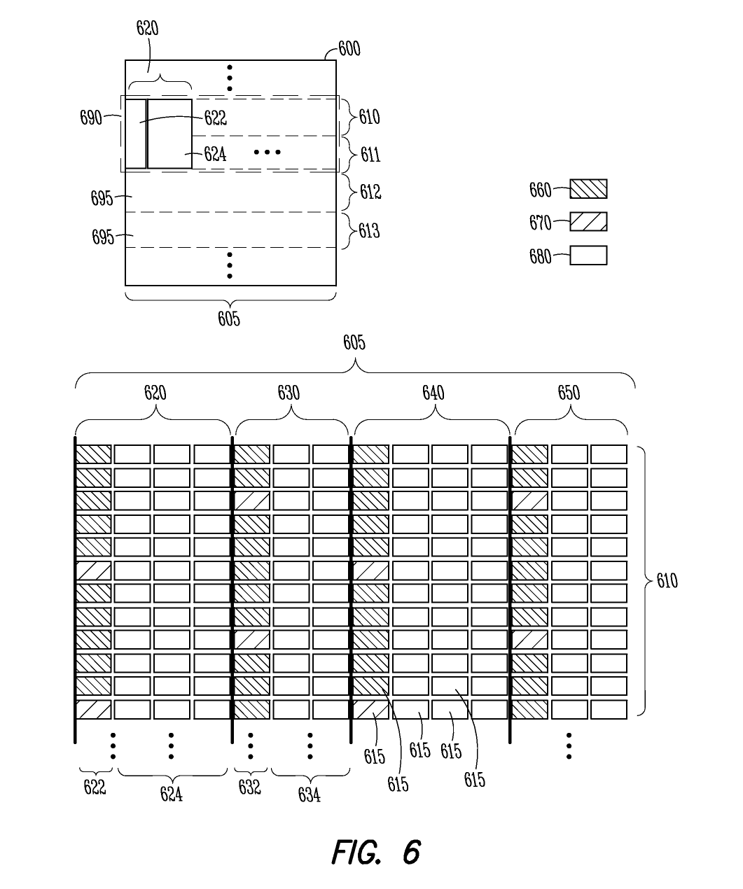

Several examples presented below and in FIGS. 6-8 illustrate various techniques and arrangements, some of which may be included in various embodiments, including those described as part of the method 500. The examples may illustrate concepts such as reduced-latency regions and normal regions for the time and frequency resources, the transmission of the HARQ blocks, support of the HARQ processes previously described or other concepts. Some embodiments may utilize some or all of the concepts shown in these examples, although the scope of the embodiments is not limited in this respect. In addition, some embodiments may include similar features and/or additional features not shown in the examples of FIG. 6-8.

As previously described, Orthogonal Frequency Division Multiplexing (OFDM) transmission of the HARQ blocks may be used in some embodiments, the frequency resources may include REs and RBs, and the time resources may include OFDM symbols and LTE sub-frames. Although the examples in FIG. 6-8 may illustrate OFDM concepts, it is understood that embodiments are not limited to OFDM transmission and reception of signals.

FIG. 6 illustrates an example of a sub-frame in accordance with some embodiments. At the top of FIG. 6, the time-frequency grid 600 shows a single LTE sub-frame 605 along with multiple RBs 610-613. It is understood that embodiments may include any suitable number of LTE sub-frames 605 and RBs 610-613 and are not limited to what is shown in FIG. 6. As an example, the time-frequency grid 600 shown for the LTE sub-frame 605 may also be used during prior and/or subsequent LTE sub-frames. As another example, more or fewer than four RBs 610-613 may be used.

For ease of illustration, an enlarged portion of the time-frequency grid 600 at the bottom of FIG. 6 shows more detail associated with the particular RB 610. The time-frequency grid 600 may comprise REs 615 in both the time and frequency dimensions, as shown in the enlarged portion at the bottom of FIG. 6. It should be pointed out that all REs 615 included are not labeled as “615” for clarity of illustration. As previously described, the REs 615 may represent the smallest unit of allocation in the time-frequency grid 600, and modulated symbols may be mapped to the REs 615 in the time-frequency grid 600 for transmission as part of one or more OFDM signals. In the example time-frequency grid 600, the RB 610 comprises 12 REs 615 in the frequency dimension and the LTE sub-frame 605 comprises 14 OFDM symbols in the time domain. Therefore, the number of REs 615 comprised by the RB 610 is 12×14=168 in this example. Such values may be selected in accordance with 3GPP or other standards in some cases, but embodiments are not limited to those values. It should also be noted that in FIG. 6, different RE 615 types are demarcated as such through dashed and clear patterns, which will be explained below.

The LTE sub-frame 605 may be divided into a number of low-latency sub-frames (LLSFs), each of which may span a contiguous group of OFDM symbols in the time dimension. As an example, the LTE sub-frame 605 may be divided into the four LLSFs 620, 630, 640, and 650, as shown in the bottom portion of FIG. 6. The LLSFs 620, 640 each may span four OFDM symbols and the LLSFs 630, 650 each may span three OFDM symbols. This example is not limiting, however, as in some embodiments, the LLSFs may span any suitable number of OFDM symbols and the number of OFDM symbols per LLSF may or may not be the same.

In addition, the LLSFs 620, 630, 640, 650 may span the RB 610 and other RBs in the frequency dimension. In some cases, available frequency resources of the system may include a number of RBs, some or all of which may be used for LLSFs such as 620, 630, 640, and 650. As an example, the LLSF 620 may span the two RBs 610 and 611 as shown in the top portion of FIG. 6. The other LLSFs 630, 640, and 650 may also span the two RBs 610 and 611, though not explicitly shown in the top portion of FIG. 6 for clarity of illustration. Accordingly, the time and frequency resources that include RBs 610 and 611 may be allocated as a reduced-latency region 690 for UEs 102 operating in the reduced-latency mode, as demarcated by a dotted-line format in FIG. 6. The region 695, which includes time and frequency resources that include RBs 612 and 613, may be allocated for UEs 102 operating in the normal mode.

As an example, the LLSF 620 may span four OFDM symbols and may comprise a low-latency data channel (LLDC) 624 for transmission of data blocks and a low-latency control channel (LLCC) 622 that includes control information related to the data blocks. As shown, the LLCC 622 may span a single OFDM symbol while the LLDC 624 may span three OFDM symbols, but this example is not limiting. For instance, the LLCCs (such as 622 and others) may span multiple OFDM symbols in embodiments. In addition, when the LLSF 620 spans multiple RBs, the LLCC 622 and the LLDC 624 may also span multiple RBs, and may span the same number of RBs as the LLSF 620 in some cases. As an example, the LLSF 620, LLCC 622, and LLDC 624 may span the two RBs 610 and 611, as shown in the top portion of FIG. 6.

As another example, the LLSF 630 may span three OFDM symbols and may comprise the LLDC 634 for transmission of data blocks and the LLCC 632 that includes control information related to the data blocks. As previously described regarding the LLSF 620, the LLCC 632 and LLDC 634 each may span one or more OFDM symbols in some embodiments, which are not limited to the example shown in FIG. 6. In addition, the LLCC 632 and the LLDC 634 may span multiple RBs in addition to the RB 610 in some embodiments, in particular when the LLSF 630 spans multiple RBs.

In some embodiments, an individual HARQ block for a reduced-latency HARQ processes may be transmitted within a single LLSF or may be restricted for transmission within the single LLSF. Accordingly, the LLSF may be configured to transmit one or more HARQ blocks (initial or diversity) for reduced-latency HARQ processes. In some cases, multiple HARQ blocks transmitted within the LLSF may be associated with multiple reduced-latency HARQ processes. It should be noted that an LLDC within the LLSF may be used for the transmission of the HARQ block(s) while an LLCC within the LLSF may include related control information. It should be noted that such features of the LLSF just described are not limited to the LLSFs shown in FIG. 6, and may also be applied to other LLSFs described herein in some cases.

Several different types of REs may be included in the time-frequency grid 600 at various locations. The REs 660 may be or may represent LLCC REs, the REs 670 may be or may represent Reference Symbols (RS), and the REs 680 (clear boxes) may be or may represent LLDC REs. Some of these types are indicated within the time-frequency grid 600 and in the legend above it in FIG. 6. The layout and locations of the RE types in the LTE sub-frame 605 as shown in FIG. 6 may be selected in accordance with 3GPP or other standards in some cases, but embodiments are not limited to what is shown in FIG. 6. For instance, locations and/or quantities of RS may be different than what is shown in FIG. 6 in some cases.

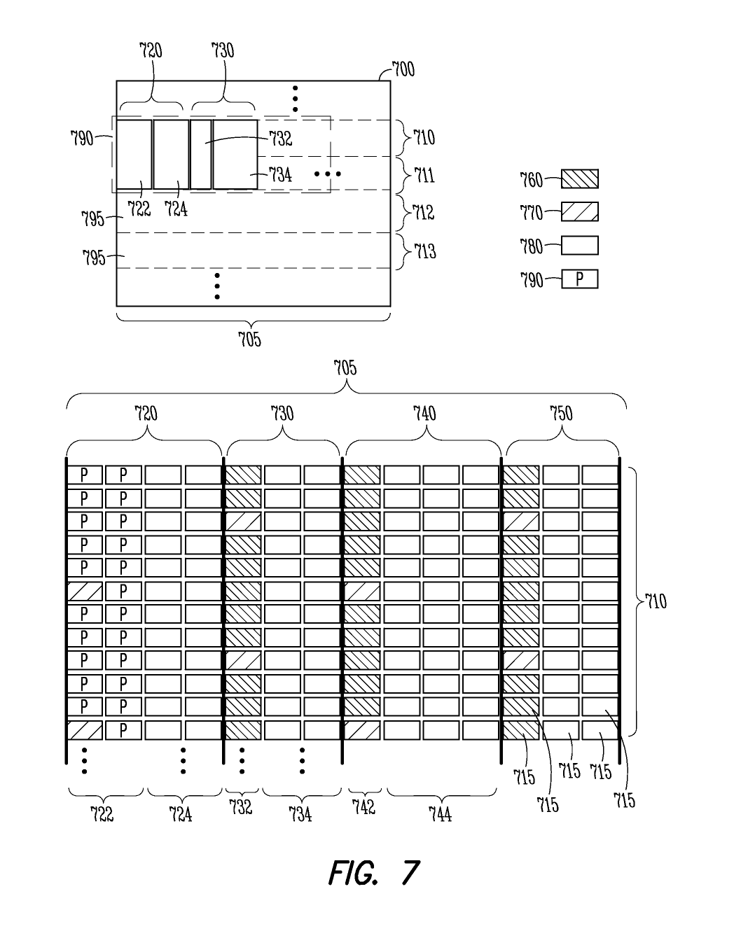

FIG. 7 illustrates another example of a sub-frame in accordance with some embodiments. Although not limited as such, some aspects and features of the example described in FIG. 6 may be applicable to the example in FIG. 7. At the top of FIG. 7, the time-frequency grid 700 shows a single LTE sub-frame 705 along with multiple RBs 710-713. An enlarged portion of the time-frequency grid 700 at the bottom of FIG. 7 shows more detail associated with the particular RB 710.

As previously described regarding the example in FIG. 6, embodiments may include any suitable number of LTE sub-frames 705 and RBs 710-713 may be used, and the time-frequency grid 700 shown for the LTE sub-frame 705 may also be used during prior and/or subsequent LTE sub-frames. The REs 715 may be similar to the REs 615, and previous discussion regarding the REs 615 may be applicable to the REs 715. Different RE 715 types are demarcated as such through various patterns including dashed and clear, which will be explained below.

The LTE sub-frame 705 may be divided into a number of low-latency sub-frames (LLSFs), each of which may span a contiguous group of OFDM symbols in the time dimension. As an example, the LTE sub-frame 705 may be divided into the four LLSFs 720, 730, 740, and 750, as shown in the bottom portion of FIG. 7. As described earlier, individual HARQ blocks for reduced-latency HARQ processes may be transmitted within a single LLSF (like 720, 730, 740 or 750), and the LLSF may be configured to transmit one or more HARQ blocks for reduced-latency HARQ processes. As previously described regarding the example in FIG. 5, the LLSFs may span three, four or any suitable number of OFDM symbols and any suitable number of RBs. Accordingly, the time and frequency resources may include a low-latency region 790 that may be allocated for UEs 102 operating in the reduced-latency mode and the region 795 may be allocated for UEs 102 operating in the normal mode.

In some embodiments, the LLSF 720 may include a Physical Downlink Control Channel (PDCCH) 722 that may span a contiguous group of one or more OFDM symbols in the time dimension. The group may include a first OFDM symbol in the LTE sub-frame 705, in some cases, such that the PDCCH occupies the first OFDM symbols in the LTE sub-frame 705. The LLSF 720 may also include a low-latency data channel (LLDC) 724 for transmission of data blocks by reduced-latency UEs 102. The PDCCH 722 may include information that identifies the time and frequency resources reserved for HARQ processes with reduced-latency UEs 102. As an example, the PDCCH 722 of may describe the allocation of LLSFs 730, 740 and 750 in terms of size, position, location within the LTE sub-frame 705 or other aspects. The PDCCH 722 may also describe allocations for the LLDC 724.

In some embodiments, the LLSFs 730, 740, and 750 may each comprise an LLDC and an LLCC, which may be similar to those described regarding the example of FIG. 5. For example, the LLDC 732 may include control information related to the LLDC 734, and the LLDC 732 is not limited to a single OFDM symbol as shown in FIG. 7.

Several different types of REs may be included in the time-frequency grid 700 at various locations. The REs 760 may be or may represent LLCC REs, the REs 770 may be or may represent Reference Symbols (RS), the REs 780 (clear boxes) may be or may represent LLDC REs, and the REs 790 shown with a “P” may be or may represent PDCCH data REs. Some of these types are indicated within the time-frequency grid 700 and in the legend above it in FIG. 7. It should be noted that the layout and locations of the RE types in the LTE sub-frame 705 as shown in FIG. 7 may be selected in accordance with 3GPP or other standards in some cases, but embodiments are not limited to what is shown in FIG. 7. For instance, locations and/or quantities of RS may be different than what is shown in FIG. 7 in some cases.

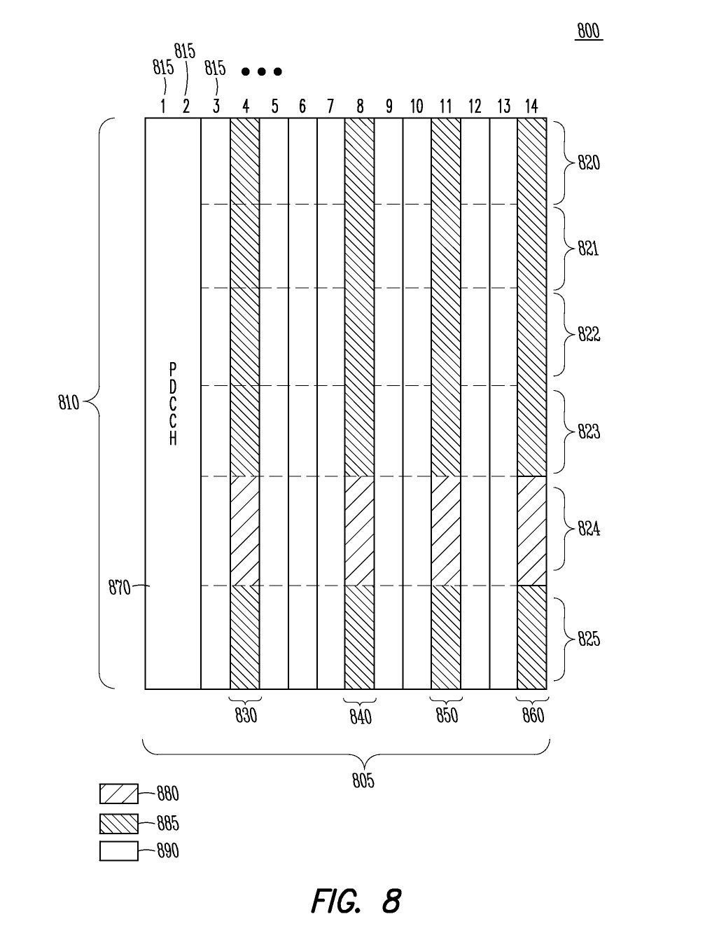

FIG. 8 illustrates another example of a sub-frame in accordance with some embodiments. Although not limited as such, some aspects and features of the example described in FIGS. 6-7 may be applicable to the example in FIG. 8. The time-frequency grid 800 shows a single LTE sub-frame 805 that includes or is divided into 14 OFDM symbols 815, which are indexed by the range 1-14. In addition, the RBs 820-825 may comprise REs similar to the REs 615, 715 previously described, although such REs are not illustrated in FIG. 8 for clarity of illustration. As previously described, embodiments are not limited to the number of LTE sub-frames 805, OFDM symbols 815, and RBs 820-825 shown in FIG. 8, and the time-frequency grid 800 shown for the LTE sub-frame 805 may also be used during prior and/or subsequent LTE sub-frames.

In some embodiments, the LTE sub-frame 805 may comprise a reduced-latency region of time and frequency resources reserved for HARQ processes with reduced-latency UEs 102 and a normal region of time and frequency resources exclusive to the reduced-latency region. Accordingly, the reduced-latency region may include one or more low-latency sub-frames (LLSFs), each of which may comprise a low-latency data channel (LLDC) for transmission of data blocks and a low-latency control channel (LLCC) that may include control information for the data blocks. The LLDC and the LLCC for each LLSF may be multiplexed in frequency during a single OFDM symbol, in some embodiments. That is, each LLSF may span some or all of the RBs and/or REs during a single OFDM symbol 815.

As an example, during the OFDM symbol #4, REs included in the RB 824 may form the LLCC for the LLSF 830, as demarcated according to the pattern 880 shown in the legend at the bottom left of FIG. 8. Also in the OFDM symbol #4, REs including in RBs 820-823 and RB 825 may form the LLDC for the LLSF 830, as demarcated according to the pattern 885 shown in the legend. Accordingly, the LLSF 830 may comprise the REs in RBs 820-825 during the OFDM symbol #4. As another example, LLSFs 840, 850, and 860 may be formed in a similar manner, such that the LTE sub-frame 805 includes four LLSFs 830, 840, 850, and 860 which occupy the RBs on the OFDM symbols #4, 8, 11, and 14. As another example not shown in FIG. 8, REs during a particular OFDM symbol 815 may be allocated in any suitable manner to form the LLCC and the LLDC for an LLSF, and the allocation may or may not be restricted to RB boundaries. That is, some or all of the RBs may include one or more REs included in the LLCC and one or more REs included in the LLDC. As described earlier, individual HARQ blocks for reduced-latency HARQ processes may be transmitted within a single LLSF (like 820, 830, 840 or 850), and the LLSF may be configured to transmit one or more HARQ blocks for reduced-latency HARQ processes.

In addition, the PDCCH 870 may span one or more OFDM symbols 815. As shown, the PDCCH 870 spans OFDM symbols #1 and #2, and spans the RBs 820-825, but this example is not limiting. The PDCCH 870 may describe the allocation of LLSFs such as 830, 840, 850 and 860, in terms of OFDM symbol index, location of the LLCC and LLDC within each LLSF or other relevant information. The PDCCH 870 may also describe allocations in the normal region of time and frequency resources (those that are exclusive to the reduced-latency region), which are demarcated according to the clear pattern 890 shown in the legend. In some embodiments, information about the normal region may be included in the PDCCH 870 in a format that is compatible with legacy PDCCH operation.

Although not shown explicitly in FIG. 8, some of the REs in the LLCCs, LLDCs, PDCCH, and other regions may be allocated for Reference Symbols (RS) or other symbols.

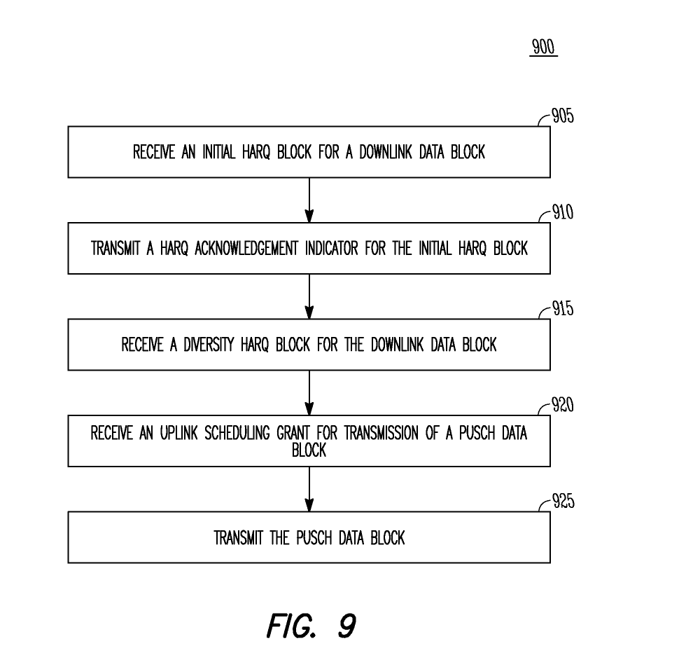

FIG. 9 illustrates the operation of another method of HARQ communication in accordance with some embodiments. As mentioned previously regarding the method 500, embodiments of the method 900 may include additional or even fewer operations or processes in comparison to what is illustrated in FIG. 9 and embodiments of the method 900 are not necessarily limited to the chronological order that is shown in FIG. 9. In describing the method 900, reference may be made to FIGS. 1-8 and 10-13, although it is understood that the method 900 may be practiced with any other suitable systems, interfaces and components. For example, reference may be made to the scenario described earlier in FIG. 4 for illustrative purposes, but the techniques and operations of the method 900 are not so limited. In addition, embodiments of the method 900 may refer to eNBs 104, UEs 102, APs, STAs or other wireless or mobile devices.

It should be noted that the method 900 may be practiced at a UE 102, and may include exchanging of signals or messages with the eNB 104. Similarly, the method 500 may be practiced at the eNB 104, and may include exchanging of signals or messages with the UE 102. In some cases, operations and techniques described as part of the method 500 may be relevant to the method 900. For instance, an operation of the method 500 may include transmission of a block by the eNB 104 while an operation of the method 900 may include reception of the same block or similar block at the UE 102.

At operation 905 of the method 900, an initial Hybrid Automatic Repeat Request (HARQ) block may be received during a first downlink sub-frame. The initial HARQ block may be based on a downlink data block. At operation 910 of the method 900, a HARQ acknowledgement indicator may be transmitted during an uplink sub-frame. The HARQ acknowledgement indicator may indicate decoding success for the downlink data block based on the received initial HARQ block. At operation 915 of the method 900, a diversity HARQ block may be received during a second downlink sub-frame. The diversity HARQ block may be based on the downlink data block, and the initial HARQ block and the diversity HARQ block enable combined decoding of the downlink data block.

In some embodiments, a time difference between the second downlink sub-frame and the uplink sub-frame and a time difference between the uplink sub-frame and the first downlink sub-frame may be less for UE 102 operation in a reduced-latency mode in comparison to UE 102 operation in a normal mode. That is, as previously described regarding the method 500, the RTD and retransmission delays may be lower for UEs 102 operating in the reduced-latency mode than for UEs 102 operating in the normal mode.

It should also be noted that HARQ traffic may be characterized as reduced-latency or normal, in some embodiments. That is, the time differences may be less for reduced-latency HARQ traffic in comparison to normal traffic. In some cases, the UE 102 may be capable of supporting a reduced-latency HARQ session in which reduced-latency HARQ traffic is received and supporting a normal HARQ session in which normal HARQ traffic is received. The reduced-latency HARQ session and the normal HARQ session may be simultaneous or overlapping in time. As an example, the UE 102 may receive an initial HARQ packet from each HARQ session during the same sub-frame. In addition, reduced-latency HARQ sessions may utilize reduced-latency resources (as previously described) while the normal HARQ sessions may utilize normal resources or resources exclusive to the reduced-latency resources.

In some embodiments, each of the uplink and downlink sub-frames may comprise a reduced-latency portion of time and frequency resources that supports HARQ processes with reduced-latency UEs 102 and may further comprise a normal portion of the time and frequency resources exclusive to the reduced-latency portion. When the UE 102 operates in the reduced-latency mode, the HARQ blocks may be received in the reduced-latency portions of the downlink sub-frames and the HARQ acknowledgement indicator may be transmitted in the reduced-latency portion of the uplink sub-frame. In addition, when the UE 102 operates in the normal mode, the HARQ blocks may be received in the normal portions of the downlink sub-frames and the HARQ acknowledgement indicator may be transmitted in the normal portion of the uplink sub-frame.

It should be noted that concepts and techniques previously described may be applicable to the method 900, such as the initial HARQ block, the diversity HARQ block, the HARQ acknowledgement indicator, and the allocation of time and frequency resources for both reduced-latency operation and normal operation. In addition, sub-frame formats described in FIGS. 6-8 and elsewhere may also be used for operations included in the method 900.

As an example, the uplink and downlink sub-frames may be configured in accordance with one or more LTE standards. The reduced-latency portion of at least one of the uplink or downlink sub-frames may include one or more low-latency sub-frames (LLSFs), each LLSF spanning a contiguous group of OFDM symbols in time. The LLSFs may comprise a low-latency data channel (LLDC) for transmission of data blocks and a low-latency control channel (LLCC) that includes control information for the data blocks.

As another example, the uplink and downlink sub-frames may be configured in accordance with one or more LTE standards, and the reduced-latency portion of at least one of the uplink or downlink sub-frames may include one or more LLSFs. Each LLSF may comprise an LLDC for transmission of data blocks and an LLCC that includes control information for the data blocks. The LLDC and the LLCC may be multiplexed in frequency during an OFDM symbol.

The example sub-frame formats just described for use in the method 900 may be similar to or the same as previously described sub-frame formats, such as those in FIGS. 6-8 or others. The uplink and downlink may use the same sub-frame format in some cases, but embodiments are not so limited, and the uplink and downlink may use different sub-frame formats in some cases. In addition, the uplink and downlink sub-frames may be time-aligned according to a common reference time such that an uplink frame and downlink frame begin at essentially the same time. However, the uplink and downlink sub-frames may also be staggered in time, in some cases. For instance, a window of time spanning the first downlink sub-frame may also span a group of final OFDM symbols included in a first uplink sub-frame and a group of initial symbols included in a second uplink sub-frame.

Returning to the method 900, at operation 920, an uplink scheduling grant may be received. The grant may be for transmission of a Physical Uplink Shared Channel (PUSCH) data block by the UE 102. At operation 925, the PUSCH data block may be transmitted. A time difference between the transmission of the PUSCH data block and the reception of the uplink scheduling grant may be lower for UE 102 operation in a reduced-latency mode in comparison to UE 102 operation in a normal mode. In some embodiments, when the UE 102 operates in the reduced-latency mode, the PUSCH data block may be transmitted in the reduced-latency portion of the uplink sub-frame. In addition, when the UE 102 operates in the normal mode, the PUSCH data block may be transmitted in the reduced-latency portion of the uplink sub-frame.

Accordingly, previous concepts regarding reduced-latency for downlink HARQ transmission may be adopted for uplink transmission of the PUSCH data block. That is, the time difference between transmissions of a HARQ block and a HARQ acknowledgement indicator may be lower for UE 102 operation in the reduced-latency mode in comparison to UE 102 operation in the normal mode.

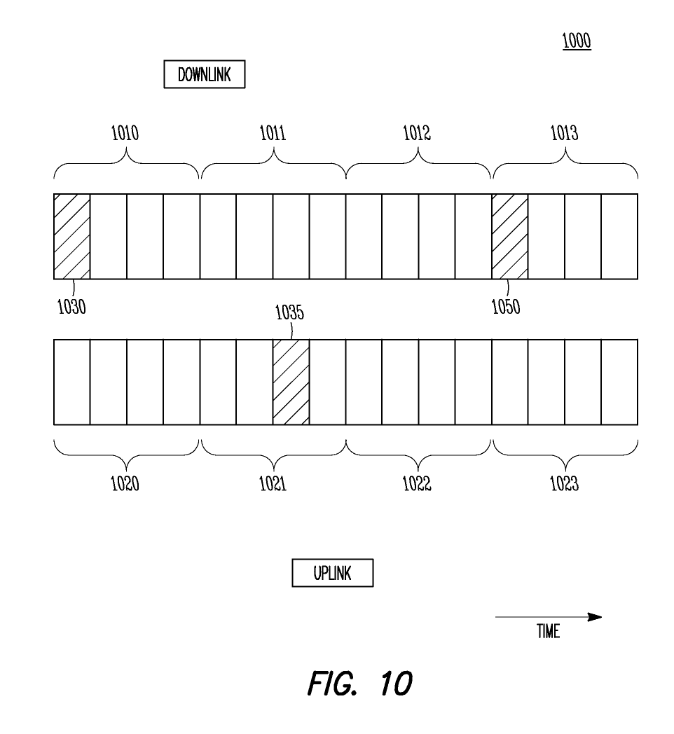

Several examples of downlink and uplink scheduling will now be presented for illustration of concepts. The use of previously discussed techniques, such as the use of low-latency sub-frames (LLSFs), may enable reduction of latency through such scheduling. FIG. 10 illustrates an example of downlink and uplink scheduling in accordance with some embodiments. In this and other examples to be described, a single HARQ process or other process may be shown for ease of illustration, but this is not limiting. As previously described, multiple HARQ processes and/or other processes may be supported in some cases.

The downlink may use sub-frames 1010-1013 while the uplink may use sub-frames 1020-1023, each of which may comprise four LLSFs. In this example, the uplink and downlink sub-frames are time-aligned, but this is not limiting. Although the LLSFs may appear to span the same number of OFDM symbols, this is not limiting, and the LLSFs may span different numbers of OFDM symbols in some cases. Though not limited, the sub-frames may be formatted according to the examples in FIGS. 6-7, in which the LLSFs may span multiple OFDM symbols.

As shown, the first downlink transmission 1030 may be performed during the first LLSF of sub-frame 1010. The uplink transmission 1035 may be performed during the third LLSF of sub-frame 1021, after five LLSFs have transpired since the downlink transmission 1035. The second downlink transmission 1050 may be performed during the first LLSF of sub-frame 1013, after five LLSFs have transpired since the downlink transmission 1035. The use of five LLSFs in between these transmissions may be selected according to decoding requirements or other factors.

As an example, the downlink transmissions 1030, 1050 may include HARQ blocks and the uplink transmission 1035 may include a HARQ acknowledgement indicator. As another example, the downlink transmissions 1030, 1050 may include uplink scheduling grants and/or physical HARQ indicator channel (PHICH) blocks and the uplink transmission 1035 may include a PUSCH data block. These processes may be reduced-latency processes as previously described. As a comparison, normal processes for UEs 102 not operating in the reduced latency mode may experience significantly more RTD and retransmission times.

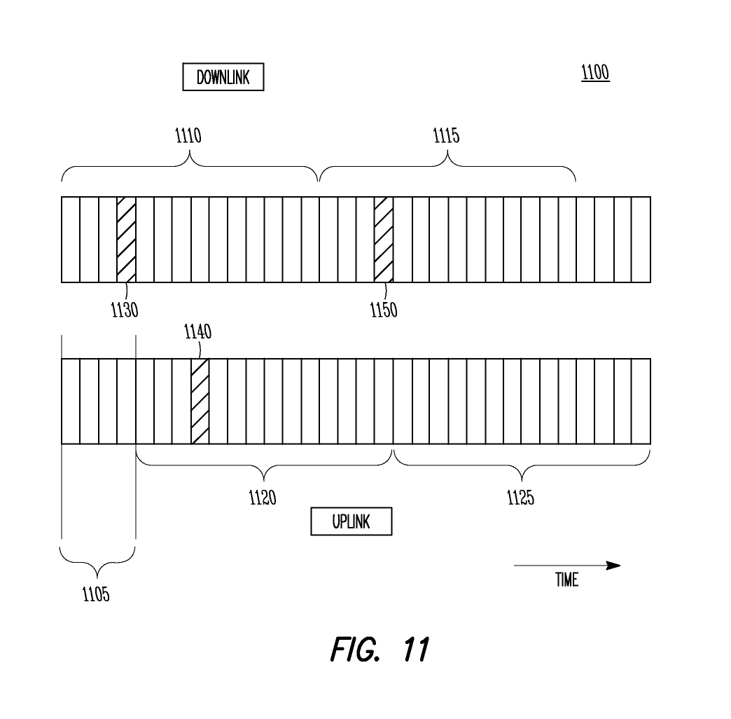

FIG. 11 illustrates another example of downlink and uplink scheduling in accordance with some embodiments. The downlink may use sub-frames 1110 and 1115 while the uplink may use sub-frames 1120 and 1125, each of which may comprise 14 OFDM symbols. In this case, the uplink and downlink sub-frames may be staggered by four OFDM symbols as shown by 1105.

Although not limited as such, the sub-frames may be formatted according to the example in FIG. 8, in which LLSFs span a single OFDM symbol. As shown, the first downlink transmission 1130 may be performed during the fourth OFDM symbol of sub-frame 1110, which may also be the first LLSF in the sub-frame 1110. The uplink transmission 1140 may be performed during the fourth OFDM symbol of sub-frame 1120, which may also be the first LLSF in the sub-frame 1120. Accordingly, four OFDM symbols may have transpired since the downlink transmission 1035. The second downlink transmission 1150 may be performed during the fourth OFDM symbol of sub-frame 1115, which may also be the first LLSF in the sub-frame 1115. Accordingly, four OFDM symbols may have transpired since the uplink transmission 1140. The use of four OFDM symbols in between these transmissions may be selected according to decoding requirements or other factors.

As described regarding the example in FIG. 10, the downlink and uplink transmissions may be or may include HARQ blocks and a HARQ acknowledgement indicator in some cases, but may also be or may include uplink scheduling grants and PUSCH data blocks. These processes may be reduced-latency processes as previously described, and normal processes for UEs 102 not operating in the reduced latency mode may experience significantly more RTD and retransmission times.

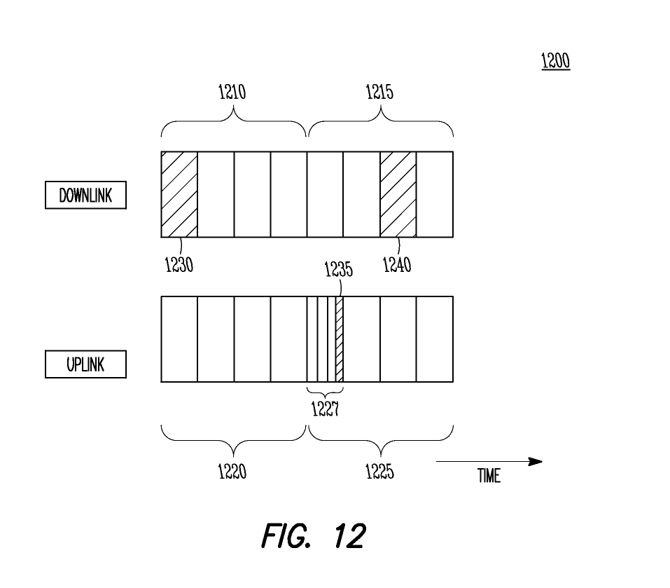

FIG. 12 illustrates another example of downlink and uplink scheduling in accordance with some embodiments. The example scenario 1200 may be similar to the scenario 1000 in FIG. 10, with a reduced interval between downlink and uplink transmissions. The reduced interval may be based on decoding complexity or other factors. It should be noted that the uplink transmission 1235 takes place in a single OFDM symbol of the LLSF 1227, which comprises four OFDM symbols in this example. Accordingly, the eNB 104 may be able to decode the data in the uplink transmission 1235 in time to perform the downlink transmission 1240, which may be based on the decoded data.

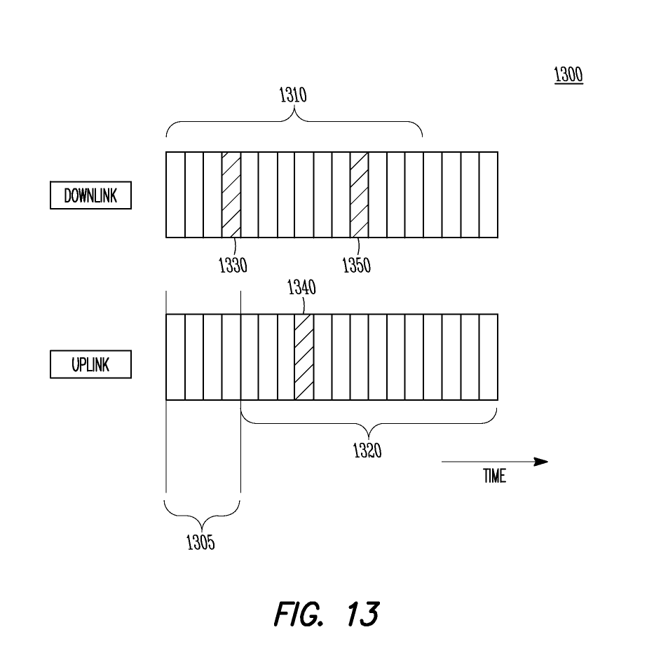

FIG. 13 illustrates another example of downlink and uplink scheduling in accordance with some embodiments. The example scenario 1300 may be similar to the scenario 1100 in FIG. 11, with a reduced interval between downlink and uplink transmissions. As in previous cases, the reduced interval may be based on decoding complexity or other factors.

An Evolved Node-B (eNB) is disclosed herein. The eNB may comprise hardware processing circuitry, including transceiver circuitry. The transceiver circuitry may be configured to, as part of a Hybrid Automatic Repeat Request (HARQ) process with a first User Equipment (UE), transmit an initial HARQ block for a first data block and transmit a diversity HARQ block for the first data block. The transmissions of the HARQ blocks for the first data block may occur during sub-frames that are spaced apart in time by a predetermined HARQ interval. The transceiver circuitry may be further configured to, as part of a HARQ process with a reduced-latency UE, transmit an initial HARQ block for a reduced-latency data block and transmit a diversity HARQ block for the reduced-latency data block. The transmissions of the HARQ blocks for the reduced-latency data block may occur during sub-frames that are spaced apart in time by a predetermined reduced-latency HARQ interval that is less than the HARQ interval.

In some embodiments, the HARQ blocks for the reduced-latency data block may be transmitted in time and frequency resources reserved for HARQ processes with reduced-latency UEs. The HARQ blocks for the first data block may be transmitted in time and frequency resources exclusive of those reserved for HARQ processes with reduced-latency UEs. In some embodiments, the sub-frames may be configured in accordance with Long Term Evolution (LTE) standards. The HARQ blocks may be transmitted using one or more Orthogonal Frequency Division Multiplexing (OFDM) signals and frequency resources of the OFDM signals may comprise multiple Resource Elements (REs).

In some embodiments, the sub-frames may comprise a reduced-latency region of time and frequency resources reserved for HARQ processes with reduced-latency UEs and a normal region of time and frequency resources exclusive to the reduced-latency region. The OFDM frequency resources may include multiple Resource Blocks (RBs) and each RB may comprise multiple REs contiguous in frequency. The reduced-latency region may include at least a portion of the RBs in frequency and multiple low-latency sub-frames (LLSFs) in time. Each LLSF may span a contiguous group of OFDM symbols. The LLSFs may comprise a low-latency data channel (LLDC) for transmission of data blocks and a low-latency control channel (LLCC) that includes control information for the data blocks.

In some embodiments, the sub-frames may comprise a reduced-latency region of time and frequency resources reserved for HARQ processes with reduced-latency UEs and a normal region of time and frequency resources exclusive to the reduced-latency region. The reduced-latency region may include one or more low-latency sub-frames (LLSFs) and each LLSF may comprise a low-latency data channel (LLDC) for transmission of data blocks and a low-latency control channel (LLCC) that includes control information for the data blocks. The LLDC and the LLCC may be multiplexed in frequency during a single OFDM symbol.

In some embodiments, each of the sub-frames may further comprise a Physical Downlink Control Channel (PDCCH) that spans a contiguous group of OFDM symbols that includes a first OFDM symbol in the sub-frame. The PDCCH may include information that identifies the time and frequency resources reserved for HARQ processes with reduced-latency UEs. In some embodiments, the initial HARQ block for the first data block and the initial HARQ block for the reduced-latency data block may be transmitted during the same sub-frame.

The hardware processing circuitry may be configured to cause the transceiver circuitry to refrain from transmission of the diversity HARQ block for the first data block when a received HARQ acknowledgement indicator for the first data block indicates successful decoding, at the first UE, of the first data block based on the initial HARQ block for the first data block. The hardware processing circuitry may be further configured to cause the transceiver circuitry to refrain from transmission of the diversity HARQ block for the reduced-latency data block when a received HARQ acknowledgement indicator for the reduced-latency data block indicates successful decoding, at the reduced-latency UE, of the reduced-latency data block based on the initial HARQ block for the reduced-latency data block.

The hardware processing circuitry may be further configured to cause the transceiver circuitry to receive, within one millisecond of the transmission of the initial HARQ block for the reduced-latency data block, an acknowledgement indicator for successful decoding, at the reduced-latency UE, of the initial HARQ block for the reduced-latency data block.

A method of Hybrid Automatic Repeat Request (HARQ) data transmission is also disclosed herein. The method may include transmitting one or more initial HARQ blocks during a group of sub-frames. Time and frequency resources of each sub-frame may comprise a reduced-latency portion reserved for reduced-latency HARQ transmissions and a normal portion exclusive to the reduced-latency portion. The method may further include receiving one or more HARQ acknowledgement indicators of successful decoding of data blocks. The method may further include transmitting, during the group of sub-frames, a diversity HARQ block for each data block not acknowledged as successfully decoded by the HARQ acknowledgement indicators. Each diversity HARQ block may be transmitted according to a predetermined spacing of sub-frames in comparison to a corresponding initial HARQ block, and the spacing for UEs operating in a reduced-latency mode may be lower than the spacing for UEs operating in a normal mode.

In some embodiments, the sub-frames may be configured in accordance with one or more Long Term Evolution (LTE) standards and the HARQ blocks may be transmitted using one or more Orthogonal Frequency Division Multiplexing (OFDM) signals that use OFDM frequency resources comprising multiple Resource Elements (REs). In some embodiments, the OFDM frequency resources may include multiple Resource Blocks (RBs) and each RB may comprise multiple REs contiguous in frequency. The reduced-latency portion may include one or more of the RBs in frequency and multiple low-latency sub-frames (LLSFs) in time. Each LLSF may span a contiguous group of OFDM symbols. The LLSFs may comprise a low-latency data channel (LLDC) for transmission of data blocks and a low-latency control channel (LLCC) that includes control information for the data blocks.

In some embodiments, the reduced-latency portion may include one or more low-latency sub-frames (LLSFs). Each LLSF may comprise a low-latency data channel (LLDC) for transmission of data blocks and a low-latency control channel (LLCC) that includes control information for the data blocks. The LLDC and the LLCC may be multiplexed in frequency during a single OFDM symbol. In some embodiments, each of the sub-frames may further comprise a Physical Downlink Control Channel (PDCCH) that spans a contiguous group of OFDM symbols that includes a first OFDM symbol in the sub-frame. The PDCCH may include information that identifies time and frequency resources of the reduced-latency portion.

A non-transitory computer-readable storage medium that stores instructions for execution by one or more processors to perform operations for Hybrid Automatic Repeat Request (HARQ) transmission is also disclosed herein. The operations may configure the one or more processors to cause a transceiver to, as part of a HARQ process with a first User Equipment (UE), transmit an initial HARQ block for a first data block and transmit a diversity HARQ block for the first data block. The transmissions of the HARQ blocks for the first data block may occur during sub-frames that are spaced apart in time by a predetermined HARQ interval. The operations may further configure the one or more processors to cause a transceiver to, as part of a HARQ process with a reduced-latency UE, transmit an initial HARQ block for a reduced-latency data block and transmit a diversity HARQ block for the reduced-latency data block. The transmissions of the HARQ blocks for the reduced-latency data block may occur during sub-frames that are spaced apart in time by a predetermined reduced-latency HARQ interval that is less than the HARQ interval.

In some embodiments, the HARQ blocks for the reduced-latency data block may be transmitted in time and frequency resources reserved for HARQ processes with reduced-latency UEs. The HARQ blocks for the first data block may be transmitted in time and frequency resources exclusive of those reserved for HARQ processes with reduced-latency UEs. In some embodiments, the sub-frames may be configured in accordance with one or more Long Term Evolution (LTE) standards and the HARQ blocks may be transmitted using one or more Orthogonal Frequency Division Multiplexing (OFDM) signals that use OFDM frequency resources comprising multiple Resource Elements (REs).

User Equipment (UE) that comprises hardware processing circuitry that includes transceiver circuitry is also disclosed herein. The transceiver circuitry may be configured to receive an initial Hybrid Automatic Repeat Request (HARQ) block during a first downlink sub-frame. The initial HARQ block may be based on a downlink data block. The transceiver circuitry may be further configured to transmit, during an uplink sub-frame, a HARQ acknowledgement indicator that indicates decoding success for the downlink data block based on the received initial HARQ block. The transceiver circuitry may be further configured to receive a diversity HARQ block during a second downlink sub-frame. The diversity HARQ block may be based on the downlink data block, and the initial HARQ block and the diversity HARQ block may enable combined decoding of the downlink data block. A time difference between the second downlink sub-frame and the uplink sub-frame and a time difference between the uplink sub-frame and the first downlink sub-frame may be less for UE operation in a reduced-latency mode in comparison to UE operation in a normal mode.

In some embodiments, the reception of the initial and diversity HARQ blocks and the transmission of the HARQ acknowledgement indicator may be performed as part of a HARQ process. The time differences may be lower for reduced-latency HARQ processes than for normal HARQ processes. The hardware processing circuitry may be further configured to support a reduced-latency HARQ process and a normal process during overlapping time periods

In some embodiments, each of the uplink and downlink sub-frames may comprise a reduced-latency portion of time and frequency resources that supports HARQ processes with reduced-latency UEs and may further comprise a normal portion of the time and frequency resources exclusive to the reduced-latency portion. In some embodiments, when the UE operates in the reduced-latency mode, the HARQ blocks may be received in the reduced-latency portions of the downlink sub-frames and the HARQ acknowledgement indicator may be transmitted in the reduced-latency portion of the uplink sub-frame. When the UE operates in the normal mode, the HARQ blocks may be received in the normal portions of the downlink sub-frames and the HARQ acknowledgement indicator may be transmitted in the normal portion of the uplink sub-frame.

In some embodiments, the uplink and downlink sub-frames may be configured in accordance with one or more Long Term Evolution (LTE) standards. The reduced-latency portion of at least one of the uplink or downlink sub-frames may include one or more low-latency sub-frames (LLSFs) and each LLSF may span a contiguous group of Orthogonal Frequency Division Multiplexing (OFDM) symbols in time. The LLSFs may comprise a low-latency data channel (LLDC) for transmission of data blocks and a low-latency control channel (LLCC) that includes control information for the data blocks.

In some embodiments, the uplink and downlink sub-frames may be configured in accordance with one or more Long Term Evolution (LTE) standards. The reduced-latency portion of at least one of the uplink or downlink sub-frames may include one or more low-latency sub-frames (LLSFs) and each LLSF may comprise a low-latency data channel (LLDC) for transmission of data blocks and a low-latency control channel (LLCC) that includes control information for the data blocks. The LLDC and the LLCC may be multiplexed in frequency during an Orthogonal Frequency Division Multiplexing (OFDM) symbol.

In some embodiments, the uplink and downlink sub-frames may be staggered in time such that a window of time spanning the first downlink sub-frame also spans a group of final OFDM symbols included in a first uplink sub-frame and a group of initial symbols included in a second uplink sub-frame. The hardware processing circuitry may be configured to cause the transceiver circuitry to receive an uplink scheduling grant for transmission of a Physical Uplink Shared Channel (PUSCH) data block by the UE. The hardware processing circuitry may be further configured to cause the transceiver circuitry to transmit the PUSCH data block according to a time difference between the transmission of the PUSCH data block and the reception of the uplink scheduling grant. The time difference may be lower for UE operation in a reduced-latency mode in comparison to UE operation in a normal mode. The time difference may be predetermined, in some embodiments.

In some embodiments, when the UE operates in the reduced-latency mode, the PUSCH data block may be transmitted in the reduced-latency portion of the uplink sub-frame. When the UE operates in the normal mode, the PUSCH data block may be transmitted in the reduced-latency portion of the uplink sub-frame.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An Evolved Node-B (eNB) comprising hardware processing circuitry including transceiver circuitry configured to:
as part of a Hybrid Automatic Repeat Request (HARQ) process with a first User Equipment (UE):
transmit an initial HARQ block for a first data block; and
transmit a diversity HARQ block for the first data block such that the transmissions of the HARQ blocks for the first data block occur during sub-frames that are spaced apart in time by a predetermined HARQ interval;
as part of a HARQ process with a reduced-latency UE:
transmit an initial HARQ block for a reduced-latency data block; and
transmit a diversity HARQ block for the reduced-latency data block such that the transmissions of the HARQ blocks for the reduced-latency data block occur during sub-frames that are spaced apart in time by a predetermined reduced-latency HARQ interval that is less than the HARQ interval.

2. The eNB according to claim 1, wherein:
the HARQ blocks for the reduced-latency data block are transmitted in time and frequency resources reserved for HARQ processes with reduced-latency UEs; and
the HARQ blocks for the first data block are transmitted in time and frequency resources exclusive of those reserved for HARQ processes with reduced-latency UEs.

3. The eNB according to claim 2, wherein:
the sub-frames are configured in accordance with one or more Long Term Evolution (LTE) standards; and
the HARQ blocks are transmitted using one or more Orthogonal Frequency Division Multiplexing (OFDM) signals and frequency resources of the OFDM signals comprise multiple Resource Elements (REs).

4. The eNB according to claim 3, wherein:
the sub-frames comprise a reduced-latency region of time and frequency resources reserved for HARQ processes with reduced-latency UEs and a normal region of time and frequency resources exclusive to the reduced-latency region;
the OFDM frequency resources include multiple Resource Blocks (RBs), each RB comprising multiple REs contiguous in frequency;
the reduced-latency region includes at least a portion of the RBs in frequency and multiple low-latency sub-frames (LLSFs) in time, each LLSF spanning a contiguous group of OFDM symbols; and
the LLSFs comprise a low-latency data channel (LLDC) for transmission of data blocks and a low-latency control channel (LLCC) that includes control information for the data blocks.

5. The eNB according to claim 3, wherein:
the sub-frames comprise a reduced-latency region of time and frequency resources reserved for HARQ processes with reduced-latency UEs and a normal region of time and frequency resources exclusive to the reduced-latency region; and
the reduced-latency region includes one or more low-latency sub-frames (LLSFs), each LLSF comprising a low-latency data channel (LLDC) for transmission of data blocks and a low-latency control channel (LLCC) that includes control information for the data blocks, wherein the LLDC and the LLCC are multiplexed in frequency during a single OFDM symbol.

6. The eNB according to claim 3, wherein:
each of the sub-frames further comprises a Physical Downlink Control Channel (PDCCH) that spans a contiguous group of OFDM symbols that includes a first OFDM symbol in the sub-frame; and
the PDCCH includes information that identifies the time and frequency resources reserved for HARQ processes with reduced-latency UEs.

7. The eNB according to claim 3, wherein the initial HARQ block for the first data block and the initial HARQ block for the reduced-latency data block are transmitted during the same sub-frame.

8. The eNB according to claim 3, the hardware processing circuitry configured to cause the transceiver circuitry to:
refrain from transmission of the diversity HARQ block for the first data block when a received HARQ acknowledgement indicator for the first data block indicates successful decoding, at the first UE, of the first data block based on the initial HARQ block for the first data block; and
refrain from transmission of the diversity HARQ block for the reduced-latency data block when a received HARQ acknowledgement indicator for the reduced-latency data block indicates successful decoding, at the reduced-latency UE, of the reduced-latency data block based on the initial HARQ block for the reduced-latency data block.

9. The eNB according to claim 1, the hardware processing circuitry configured to cause the transceiver circuitry to receive, within one millisecond of the transmission of the initial HARQ block for the reduced-latency data block, an acknowledgement indicator for successful decoding, at the reduced-latency UE, of the initial HARQ block for the reduced-latency data block.

10. The eNB according to claim 1, wherein:
the HARQ blocks for the reduced-latency data block are transmitted in time and frequency resources reserved for reduced-latency HARQ traffic; and
the HARQ blocks for the first data block are transmitted in time and frequency resources exclusive of those reserved for reduced-latency HARQ traffic.

11. A method of Hybrid Automatic Repeat Request (HARQ) data transmission, the method comprising:
transmitting one or more initial HARQ blocks during a group of sub-frames, wherein time and frequency resources of each sub-frame comprise a reduced-latency portion reserved for reduced-latency HARQ transmissions and a normal portion exclusive to the reduced-latency portion; and
receiving one or more HARQ acknowledgement indicators of successful decoding of data blocks; and
transmitting, during the group of sub-frames, a diversity HARQ block for each data block not acknowledged as successfully decoded by the HARQ acknowledgement indicators; and
wherein each diversity HARQ block is transmitted according to a predetermined spacing of sub-frames in comparison to a corresponding initial HARQ block, and the spacing for the reduced-latency portion is lower than the spacing for the normal portion.

12. The method according to claim 11, wherein:
the sub-frames are configured in accordance with one or more Long Term Evolution (LTE) standards; and
the HARQ blocks are transmitted using one or more Orthogonal Frequency Division Multiplexing (OFDM) signals that use OFDM frequency resources comprising multiple Resource Elements (REs).

13. The method according to claim 12, wherein
the OFDM frequency resources include multiple Resource Blocks (RBs), each RB comprising multiple REs contiguous in frequency;
the reduced-latency portion includes one or more of the RBs in frequency and multiple low-latency sub-frames (LLSFs) in time, each LLSF spanning a contiguous group of OFDM symbols; and
the LLSFs comprise a low-latency data channel (LLDC) for transmission of data blocks and a low-latency control channel (LLCC) that includes control information for the data blocks.

14. The method according to claim 12, wherein the reduced-latency portion includes one or more low-latency sub-frames (LLSFs), each LLSF comprising a low-latency data channel (LLDC) for transmission of data blocks and a low-latency control channel (LLCC) that includes control information for the data blocks, the LLDC and the LLCC multiplexed in frequency during a single OFDM symbol.

15. The method according to claim 12, wherein:
each of the sub-frames further comprises a Physical Downlink Control Channel (PDCCH) that spans a contiguous group of OFDM symbols that includes a first OFDM symbol in the sub-frame; and
the PDCCH includes information that identifies time and frequency resources of the reduced-latency portion.

16. A non-transitory computer-readable storage medium that stores instructions for execution by one or more processors to perform operations for Hybrid Automatic Repeat Request (HARQ) transmission, the operations to configure the one or more processors to cause a transceiver to:
as part of a HARQ process with a first User Equipment (UE):
transmit an initial HARQ block for a first data block; and
transmit a diversity HARQ block for the first data block such that the transmissions of the HARQ blocks for the first data block occur during sub-frames that are spaced apart in time by a predetermined HARQ interval;
as part of a HARQ process with a reduced-latency UE:
transmit an initial HARQ block for a reduced-latency data block; and
transmit a diversity HARQ block for the reduced-latency data block such that the transmissions of the HARQ blocks for the reduced-latency data block occur during sub-frames that are spaced apart in time by a predetermined reduced-latency HARQ interval that is less than the HARQ interval.

17. The non-transitory computer-readable storage medium according to claim 16, wherein:
the HARQ blocks for the reduced-latency data block are transmitted in time and frequency resources reserved for HARQ processes with reduced-latency UEs; and
the HARQ blocks for the first data block are transmitted in time and frequency resources exclusive of those reserved for HARQ processes with reduced-latency UEs.

18. The non-transitory computer-readable storage medium according to claim 17, wherein:
the sub-frames are configured in accordance with one or more Long Term Evolution (LTE) standards; and
the HARQ blocks are transmitted using one or more Orthogonal Frequency Division Multiplexing (OFDM) signals that use OFDM frequency resources comprising multiple Resource Elements (REs).

19. User Equipment (UE) comprising hardware processing circuitry including transceiver circuitry configured to:
receive an initial Hybrid Automatic Repeat Request (HARQ) block during a first downlink sub-frame, the initial HARQ block based on a downlink data block;
transmit, during an uplink sub-frame, a HARQ acknowledgement indicator that indicates decoding success for the downlink data block based on the received initial HARQ block; and
receive a diversity HARQ block during a second downlink sub-frame, wherein the diversity HARQ block is based on the downlink data block, and the initial HARQ block and the diversity HARQ block enable combined decoding of the downlink data block,
wherein a time difference between the second downlink sub-frame and the uplink sub-frame and a time difference between the uplink sub-frame and the first downlink sub-frame are less for UE operation in a reduced-latency mode in comparison to UE operation in a normal mode.

20. The UE according to claim 19, wherein each of the uplink and downlink sub-frames comprises a reduced-latency portion of time and frequency resources for the reduced-latency mode and further comprises a normal portion of the time and frequency resources exclusive to the reduced-latency portion.

21. The UE according to claim 20, wherein:
when the UE operates in the reduced-latency mode, the HARQ blocks are received in the reduced-latency portions of the downlink sub-frames and the HARQ acknowledgement indicator is transmitted in the reduced-latency portion of the uplink sub-frame; and
when the UE operates in the normal mode, the HARQ blocks are received in the normal portions of the downlink sub-frames and the HARQ acknowledgement indicator is transmitted in the normal portion of the uplink sub-frame.

22. The UE according to claim 21, wherein:
the uplink and downlink sub-frames are configured in accordance with one or more Long Term Evolution (LTE) standards;
the reduced-latency portion of at least one of the uplink or downlink sub-frames includes one or more low-latency sub-frames (LLSFs), each LLSF spanning a contiguous group of Orthogonal Frequency Division Multiplexing (OFDM) symbols in time; and
the LLSFs comprise a low-latency data channel (LLDC) for transmission of data blocks and a low-latency control channel (LLCC) that includes control information for the data blocks.

23. The UE according to claim 21, wherein:
the uplink and downlink sub-frames are configured in accordance with one or more Long Term Evolution (LTE) standards;
the reduced-latency portion of at least one of the uplink or downlink sub-frames includes one or more low-latency sub-frames (LLSFs), each LLSF comprising a low-latency data channel (LLDC) for transmission of data blocks and a low-latency control channel (LLCC) that includes control information for the data blocks, wherein the LLDC and the LLCC are multiplexed in frequency during an Orthogonal Frequency Division Multiplexing (OFDM) symbol.

24. The UE according to claim 23, wherein the uplink and downlink sub-frames are staggered in time such that a window of time spanning the first downlink sub-frame also spans a group of final OFDM symbols included in a first uplink sub-frame and a group of initial symbols included in a second uplink sub-frame.

25. The UE according to claim 21, the hardware processing circuitry configured to cause the transceiver circuitry to:
receive an uplink scheduling grant for transmission of a Physical Uplink Shared Channel (PUSCH) data block by the UE; and
transmit the PUSCH data block according to a time difference between the transmission of the PUSCH data block and the reception of the uplink scheduling grant that is predetermined, wherein the time difference is lower for UE operation in a reduced-latency mode in comparison to UE operation in a normal mode.

26. The UE according to claim 25, wherein:
when the UE operates in the reduced-latency mode, the PUSCH data block is transmitted in the reduced-latency portion of the uplink sub-frame; and
when the UE operates in the normal mode, the PUSCH data block is transmitted in the reduced-latency portion of the uplink sub-frame.

27. The UE according to claim 19, wherein:
the reception of the initial and diversity HARQ blocks and the transmission of the HARQ acknowledgement indicator are performed as part of a HARQ process;
the time differences are lower for reduced-latency HARQ processes than for normal HARQ processes; and
the hardware processing circuitry is further configured to support a reduced-latency HARQ process and a normal process during overlapping time periods.
